(19) United States
(12) Patent Application Publication
(10) Pub. No.: US 2013/0067924 A1
(43) Pub. Date: Mar. 21, 2013

(54) COMBUSTIBLE FLUID FUEL

(71) Applicants: Alexander Schoenfeld, Herzliya Pituach (IL); Yaco Nesher, Petah-Tikva (IL); Joshua Altman, Tel Aviv (IL); Moshe Tshuva, Tel Aviv (IL)

(72) Inventors: Alexander Schoenfeld, Herzliya Pituach (IL); Yaco Nesher, Petah-Tikva (IL); Joshua Altman, Tel Aviv (IL); Moshe Tshuva, Tel Aviv (IL)

(21) Appl. No.: 13/381,377

(22) PCT Filed: Jul. 1, 2010
(86) PCT No.: PCT/IL2010/000529

§ 371 Date: Nov. 29, 2012

Related U.S. Application Data
(60) Provisional application No. 61/222,130, filed on Jul. 1, 2009.

(51) Int. Cl. C10L 1/32; F02C 3/20; F02M 25/00

(52) U.S. Cl. CPC C10L 1/322; F02M 25/00; F02C 3/20
USPC 60/772; 123/1 A; 44/281

(57) ABSTRACT

Disclosed are combustible fluid fuels that in some embodiments include a high-explosive component.

### FIELD AND BACKGROUND OF THE INVENTION

The invention, in some embodiments, relates to the field of fuels and more particularly, but not exclusively, to fuels that in some embodiments are combustible in reciprocating internal combustion engines.

Wheeled motor vehicles are an inseparable part of a modern industrial society, to providing cheap, simple and efficient transport of people and goods. Such societies would function with great difficulty without automobiles, trucks and buses which allow for efficient concentration and distribution of industrial, commercial and residential loci.

The ubiquity of motor vehicles is in a large part a result of the existence of the reciprocating internal combustion engines, primarily Otto-cycle and Diesel-cycle engines powered by hydrocarbon fossil fuel.

As the price of fossil fuels increases there is a need to find additional fuel sources.

### SUMMARY OF THE INVENTION

Some embodiments of the invention relate to combustible fluid fuels that, in some aspects, have advantages over known combustible fluid fuels. Some embodiments of the invention relate to combustible fluid fuels including a high-explosive material.

Aspects of the invention are described in the specification hereinbelow and in the appended claims.

Unless otherwise defined, all technical and scientific terms used herein have the same meaning as commonly understood by one of ordinary skill in the art to which the invention pertains. In case of conflict, the specification, including definitions, will control.

As used herein, the indefinite articles “a” and “an” mean “at least one” or “one or more” unless the context clearly dictates otherwise.

### DESCRIPTION OF SOME EMBODIMENTS OF THE INVENTION

The invention, in some embodiments thereof, relates to combustible fluid fuels that include a high-explosive material.

The principles, uses and implementations of the teachings of the invention may be better understood with reference to the accompanying description. Upon perusal of the description and figures present herein, one skilled in the art is able to implement the teachings of the invention without undue effort or experimentation.

Embodiments of the invention relate to a combustible fluid fuel, comprising:

a) a high-explosive material; and

b) a fluid carrier

wherein the fuel comprises not less than about 20% by weight of the high-explosive material; and
wherein the fuel comprises not less than about 30% by weight of the fluid carrier.

In some embodiments, the high-explosive material is dissolved in the fluid carrier which functions as a solvent so that the fuel is fluid at a temperature of 273K at atmospheric pressure and the fluid carrier includes not less than about 50% aromatic components

In some embodiments, the high-explosive material is in a particulate form in a continuous phase substantially of the fluid carrier. In some such embodiments, the high-explosive material is in the form of a solid particulate, for example the fluid fuel is substantially a slurry, suspension or a colloid. In some embodiments, the high-explosive material is in the form of a liquid particulate and the fluid fuel is substantially an emulsion.

High-explosive materials are not known for use as fuels. When placed inside an enclosure such as the combustion chamber of a reciprocating internal combustion engine, high-explosive materials tend to explode, destroying the engine.

It has surprisingly been found that fluid fuel comprising not less than 20% by weight high-explosive material and not less than 50% by weight fluid carrier is useable as a combustible fluid fuel for a reciprocating internal combustion engine.

Without wishing to be held to any one theory, it is believed that the fluid carrier not only holds the high-explosive material so that the fuel is a substantially homogenous fluid, allowing simple transport of the fuel to a combustion chamber, but changes the combustion characteristics of the fuel to be similar to that of fuels known for use in reciprocating internal combustion engines.

In some embodiments, a combustible fluid fuel deflagrates instead of detonating inside the combustion chamber of an engine.

### Fluid Carrier

A fluid carrier used for implementing a combustible fluid fuel of the invention holds the high-explosive material so that the fuel is substantially homogenous and fluid at a temperature of 273K at atmospheric pressure.

Generally, a fluid carrier is combustible. Suitable fluid carriers include oils, alcohols, hydrocarbons, for example, paraffin, synthetic polyalphaolefins, fuel oil, kerosene, diesel fuel, gasoline, alpha-olefins (e.g., 1-hexene) and ester-based oils such as DOP (bis (2-ethylhexyl phthalate).

In some embodiments, a fluid carrier is a solvent for the high-explosive material and includes not less than about 50% by weight aromatic components. In some embodiments the solvent includes not less than about 60%, not less than about 70%, not less than about 80%, not less than about 90% and even not less than about 95% by weight aromatic components. Any suitable aromatic material may be used as a component of a solvent of a combustible fluid fuel of the invention. Suitable aromatic components include, but are not limited to at least one component selected from the group consisting of benzene, monosubstituted (especially alkyl) substituted benzenes (e.g., toluene, ethylbenzene, chlorobenzene), disubstituted (especially alkyl) substituted benzenes (e.g., xylene, o-xylene, m-xylene, p-xylene), trisubstituted (especially alkyl) substituted benzenes (e.g., mesitylene, 1,2,4-trimethylbenzene), aniline, benzyl alcohol, benzaldehyde and mixtures thereof. Without wishing to be held to any one theory, it is believed that in some such embodiments, the solvent not only dissolves the high-explosive material so that the fuel is fluid, allowing simple transport of the fuel to a combustion chamber, but changes the combustion characteristics of the solution to be similar to that of fuels known for use in reciprocating internal combustion engines.

### High-Explosive Material

A high-explosive material used for implementing the teachings of the invention is any suitable high-explosive material. Suitable high-explosive materials include, but are not limited to, high-explosive materials selected from the group consisting of TNT (trinitrotoluene), RDX (cyclotrimethylene trinitramine), TNT/RDX mixtures, nitroglycerine, HMX (cyclotetramethylene tetranitramine), hexogen and mixtures thereof.

In some embodiments the combustible fluid fuel comprises not less than about 20%, not less than about 25% and even not less than about 30% of the high explosive material by weight of the fuel.

In embodiments of a combustible fluid fuel where the high-explosive material is a. solid particulate, the high-explosive material is present in any suitable particle size. In some embodiments, the particle size is on the order of about 1000 micrometers (e.g., an average particle size of between about 500 and 2000 micrometers). In some embodiments, the particle size is on the order of about 100 micrometers (e.g., an average particle size of between about 50 and 5000 micrometers). In some embodiments, the particle size is on the order of about 10 micrometers (e.g., an average particle size of between about 5 and 50 micrometers). In some embodiments, the particle size is on the order of about 1 micrometer (e.g., an average particle size of between about 0.5 and 5 micrometer).

### Additional Components

In some embodiments, a combustible fluid fuel comprises additional components including water (for example, as a combustion moderator), viscosity modifiers, emulsifiers, suspension agents and “antifreeze”, components that prevent solidification of the combustible fluid fuel at above 0° C.

### Use of Combustible Fluid Fuels

In some embodiments, a combustible fluid fuel as described herein is used for generating heat for driving a turbine. Specifically, in some embodiments, a combustible fluid fuel is combusted in a combustion chamber (for example of a furnace or the like) and heats a fluid. The hot fluid is then used to drive a turbine for generating electricity. In some embodiments, the fluid is isolated in a closed system as is known in the art of generating electricity. For example, in some embodiments, the combustible fluid fuel is burnt in a furnace and the produced heat used to operate a steam turbine.

In some embodiments, there is provided for the use of a combustible fluid fuel as described herein as a fuel for a reciprocating internal combustion engine, especially an air-breathing engine.

In some embodiments, there is provided for a method of operating an internal combustion engine, comprising: a) providing a reciprocating internal-combustion engine; b) combusting a combustible fluid fuel as described herein in a combustion chamber of the engine to power the engine to produce torque. In some embodiments, the combustible fluid fuel is combusted in the combustion chamber together with air.

In some embodiments the reciprocating internal combustion engine is a Diesel-cycle engine.

In some embodiments the reciprocating internal combustion engine is an Otto-cycle engine.

In some embodiments, the engine is an engine configured for burning a hydrocarbon fuel (e.g., diesel, gasoline, fuel oil) and the combustible fluid fuel is combusted without substantial modification to the combustion chamber of the engine, although not-substantial modifications such as modification of timing and ignition cycles may be required. Such embodiments allow for the use of a combustible fluid fuel as described herein to be used with engines such as known in the art.

### EXAMPLES

Reference is now made to the following examples, which together with the above descriptions illustrate some embodiments of the invention in a non limiting fashion.

As is seen in the examples below, in some embodiments during combustion the high-explosive material and solvent of the fuel are oxidized to produce CO₂, H₂O to and N₂.

### Example 1

### TNT/Toluene

An embodiment of a combustible fluid fuel comprises 35% by weight TNT in 65% toluene. The fuel is used in the usual way as fuel for a two-stroke Diesel cycle engine. Oxygen is provided in the combustion chamber for combustion, in the usual way, as air through the air inlet of the engine.

During combustion:

(TNT) 2C₇H₅N₃O₆+10.5O₂->14CO₂+5H₂O+3N₂

(toluene) 2C₇H₈+18 O₂->14CO₂+8H₂O

### Example 2

### TNT/Benzene

An embodiment of a combustible fluid fuel comprises 30% by weight TNT in 70% benzene and used as in Example 1.

During combustion:

(TNT) 2C₇H₅N₃O₆+10.5O₂->14CO₂+5H₂O+3N₂

(benzene) 2 C₆H₆+15O₂->12CO₂+6H₂O

### Example 3

### TNT/Benzyl Alcohol

An embodiment of a combustible fluid fuel comprises 25% by weight TNT in 75% benzyl. alcohol and used as in Example 1.

During combustion:

(TNT) 2C₇H₅N₃O₆+27O₂->14CO₂+5H₂O+3 N₂

(benzyl alcohol) 2C₇H₈O+17O₂->14CO₂+8H₂O

### Example 4

### Nitroglycerin/Toluene

An embodiment of a combustible fluid fuel comprises 20% by weight nitroglycerin in 80% toluene and used as in Example 1.

During combustion:

(nitroglycerin) 2C₃H₅N₃O₉->6CO₂+5H₂O+3N₂+0.5O₂*

(toluene) 2C₇H₈+18O₂*->14CO₂+8H₂O

* Some of the excess oxygen from the nitroglycerin oxidizes the toluene.

### Example 5

### RDX/DOP

An embodiment of a combustible fluid fuel comprises substantial equimolar amounts of RDX (1,3,5-Trinitro-1,3,5-triazacyclohexane, C₃H₆N₆O₆, MW=222, as a solid powder having an average particle diameter of about 500 nanometer) as a high-explosive material (36% by weight) and DOP (bis (2-ethylehexyl phthalate, C₂₄H₃₈O₄, MW=391) as a fluid carrier (64% by weight)

During combustion:

C₃H₆N₆O₆+C₂₄H₃₈O₄+34O₂->27CO₂+22H₂O+3N₂

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A combustible fluid fuel, comprising:
a) a high-explosive material; and
b) a fluid carrier
wherein said fuel comprises not less than about 20% by weight of said high-explosive material; and
wherein said fuel comprises not less than about 30% by weight of the fluid carrier.

2. The combustible fluid fuel of claim 1, wherein:
said fluid carrier includes not less than about 50% aromatic components; and said high-explosive material is substantially dissolved in said fluid carrier so that the fuel is fluid at a temperature of 273° K at atmospheric pressure.

3. The combustible fluid fuel of claim 1, wherein said high-explosive material is in a particulate form in a continuous phase, substantially of said fluid carrier.

4. (canceled)

5. A use of the combustible fluid fuel of claim 1 as a fuel for a reciprocating internal combustion engine.

6. The use of claim 5, wherein said engine is an air-breathing engine.

7. A method of driving a turbine, comprising:
a) combusting a combustible fluid fuel of any of the preceding claims in a combustion chamber to produce heat;
b) heating a fluid with said produced heat; and
c) using said heated fluid to drive a turbine.

8. A method of operating an internal combustion engine, comprising:
a) providing a reciprocating internal-combustion engine;
b) combusting the combustible fluid fuel of claim 1 in a combustion chamber of said engine to power said engine to produce torque.

9. The method of claim 8, wherein said combustible fluid fuel is combusted in said combustion chamber together with air.

10. The method of claim 8, wherein said engine is configured for burning a hydrocarbon fuel; and
said combustible fluid fuel is combusted without substantial modification to a combustion chamber of said engine.
